(19) United States
(12) Patent Application Publication
(10) Pub. No.: US 2015/0068975 A1
(43) Pub. Date: Mar. 12, 2015

(54) WEAR-RESISTANT LINER SYSTEM AND METHOD

(71) Applicant: Energy Recovery, Inc., San Leandro, CA (US)

(72) Inventor: Prem Krish, Foster City, CA (US)

(21) Appl. No.: 14/481,718

(22) Filed: Sep. 9, 2014

Related U.S. Application Data
(60) Provisional application No. 61/876,132, filed on Sep. 10, 2013.

(51) Int. Cl. B04C 5/085; B29C 45/14

(52) U.S. Cl. CPC B04C 5/085; B29C 45/14778; B29L 2031/00
USPC 210/512.1; 264/261; 524/590

(57) ABSTRACT

A system includes a wear-resistant liner that includes a matrix material and a plurality of inserts embedded within the matrix material. One or more inserts of the plurality of inserts includes a retention feature. The retention feature is configured to increase adhesion between the one or more inserts of the plurality of inserts and the matrix material.

### CROSS REFERENCE TO RELATED APPLICATION

This application claims priority to and benefit of U.S. Provisional Patent Application No. 61/876132, entitled “CERAMIC INSERT DESIGN FOR WEAR LINERS,” filed Sep. 10, 2013, which is herein incorporated by reference in its entirety for all purposes.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

The subject matter disclosed herein relates to wear protection, and more particularly, to wear liners for high wear and high impact applications, such as mineral processing equipment.

A variety of processing equipment may include surfaces that are subjected to high wear and high impact. For example, such processing equipment may include classification (e.g., sizing) equipment used to classify or separate different phases of a multi-phase flow. Some multi-phase flows may include solids, particles, debris, and so forth, which may be abrasive and/or erosive, and thus, may increase wear on surfaces of the processing equipment. This wear may increase maintenance costs related to downtime and replacement parts.

### BRIEF DESCRIPTION OF THE DRAWINGS

Various features, aspects, and advantages of the present invention will become better understood when the following detailed description is read with reference to the accompanying figures in which like characters represent like parts throughout the figures, wherein:

FIG. 1 is a partial perspective cross-sectional view of an embodiment of a classifier with a wear-resistant liner;

FIG. 2 is a cross-sectional view of an embodiment of a wear-resistant liner including a plurality of inserts with retention features embedded within a matrix material;

FIG. 3 is a perspective view of an embodiment of an insert with retention features;

FIG. 4 is a perspective view of an embodiment of an insert with retention features;

FIG. 5 is a perspective view of an embodiment of an insert with retention features;

FIG. 6 is a perspective view of an embodiment of an insert with retention features;

FIG. 7 is a perspective view of an embodiment of an insert with retention features; and

FIG. 8 is a method for manufacturing a wear-resistant liner including a plurality of inserts with retention features embedded within a matrix material.

### DETAILED DESCRIPTION OF SPECIFIC EMBODIMENTS

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As discussed in detail below, the disclosed embodiments relate generally to wear protection, and more particularly to wear liners for high wear and high impact equipment. For example, high wear and high impact equipment may include classification equipment (e.g., hydrocyclones) that separate or classify phases of a multi-phase flow and/or pipes used to convey a flow (e.g., a multi-phase flow). The classification equipment and pipes may be used with a flow (e.g., slurry) that includes solids (e.g., balls from ball mills, particles, debris, etc.). Additionally, the flow may have a high velocity, and in some instances, the flow may contact surfaces of the classification equipment or pipes. For example, in certain mining applications, a hydrocyclone may receive a mineral slurry including steel balls (e.g., from ball mills or semi-autogenous mills), which may be up to 5 centimeters in diameter and may weigh up to 500 grams. As such, some flows, particularly high velocity flows including solids, may cause wear on surfaces of the classification equipment and/or pipes due to high impact, abrasion, and/or erosion.

Accordingly, liners may be manufactured for classification equipment and pipes using the disclosed techniques to reduce wear (e.g., due to impact, abrasion, and/or erosion) on inner surfaces of the classification equipment and pipes. The liners may therefore increase the life of the surfaces when handling multi-phase flows with solids, such as balls from ball mills, particles, debris, etc. In certain embodiments, a composite liner may include two or more materials. For example, a liner may be manufactured by embedding inserts (e.g., ceramic inserts) into an elastomeric matrix (e.g., polyurethane). The inserts may be secured within the elastomeric matrix by adhesion forces at interfaces between the inserts and the elastomeric matrix. However, wear (e.g., due to high impact, abrasion, and/or erosion) on the liner may cause the insert and the elastomeric matrix to separate at an interface, allowing one or more of the inserts to be ejected from the elastomeric matrix. Loss of one or more inserts increase wear of the surrounding inserts from increased exposure of the interfaces between the inserts and the elastomeric matrix to the multi-phase fluid. This increased wear then may lead to the ejection of clusters of neighboring inserts from the elastomeric matrix.

Accordingly, the disclosed techniques relate to inserts that may include retention features (e.g., mechanical locking features, interfacial adhesion features, etc.) to increase the retention of the inserts within a matrix material. In particular, the disclosed retention features may increase the surface area of the interface between the inserts and the matrix material, which increases the adhesion forces between the inserts and the matrix material. Accordingly, use of the disclosed techniques may increase the life of high wear liners, thereby decreasing the costs and downtime associated with replacing or repairing the liners.

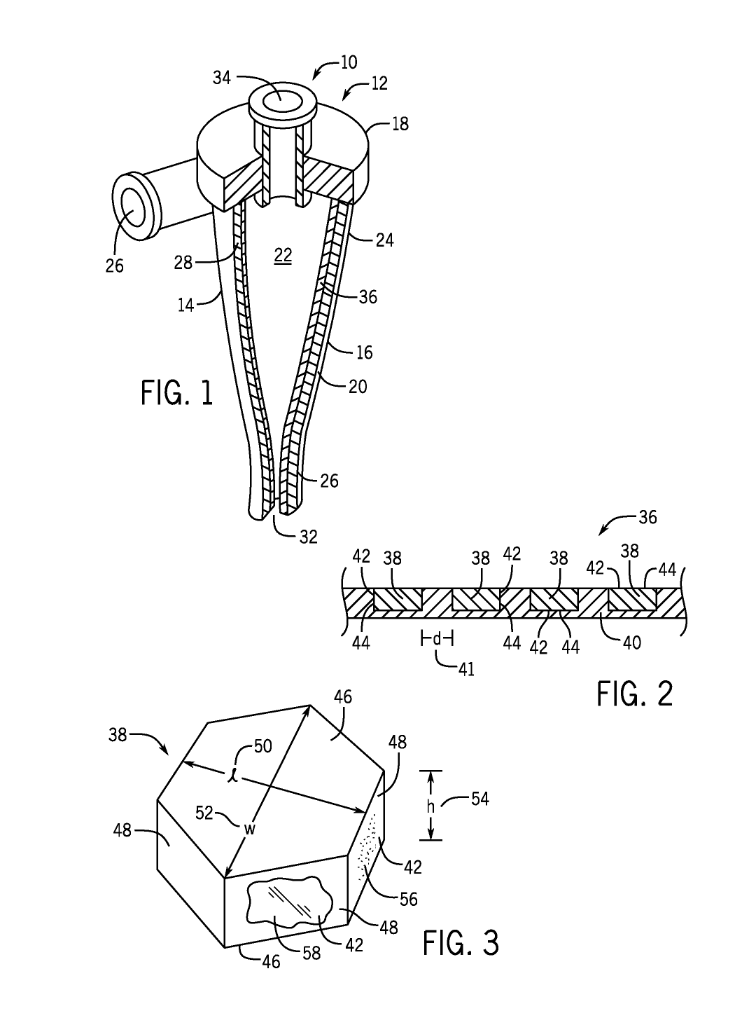

FIG. 1 is a partial perspective cross-sectional view of a classifier 10 including a wear-resistant liner 36 manufactured using the disclosed techniques. While the illustrated embodiment of the classifier 10 is a hydrocyclone 12, it should be appreciated that in other embodiments, the classifier 10 may be a gas cyclone, an ore sorter, a fluidized bed classifier, or any other suitable classifying equipment that has a surface exposed to solids, particles, or debris in a multi-phase flow. Further, while the hydrocyclone 12 is described below in the context of a liquid/solid hydrocylcone, it should be appreciated that in other embodiments, the hydrocyclone may be configured to separate liquid/liquid mixtures or solid/solid mixtures. Additionally, the classifier 10 described herein may be used in a variety of industries and applications, such as the mining and mineral processing industry; the metal working industry; the drilling industry (e.g., petroleum industry); pulp and paper mills; etc. Further, it should be noted that the disclosed techniques are also applicable to pipes configured to convey an abrasive and/or high impact flow and any other components exposed to an abrasive and/or high impact flow.

The classifier 10 includes a housing 14 having a separation portion 16 and a head portion 18 (e.g., cap). The separation portion 16 includes a sidewall 20 and a tapered chamber 22. In particular, the tapered chamber 22 may taper from a large diameter portion 24 to a small diameter portion 26. The head portion 18 includes at least one tangential inlet 26 configured to receive a multi-phase flow. The multi-phase flow enters through the inlet 26 and flows spirally downwards toward the separation portion 16. The spin velocity of the multi-phase flow increases as the multi-phase flow descends. The spinning motion generates strong centripetal forces which causes the phases (e.g., solids and liquids) of the multi-phase flow to separate. Heavier (e.g., denser) liquid and/or solids impinge upon inner surfaces 28 of the separation portion 16 and the head portion 18 and exit through an underflow outlet 32. The lighter (e.g., less dense) liquids and/or solids migrate toward a center of the chamber 22 and move upwards to exit through an overflow outlet 34.

In some embodiments, the multi-phase flow may be slurry including abrasive solids, balls from ball mills, particles, debris and so forth. The abrasive solids, balls, particles, and debris, which impinge upon the inner surfaces 28 at high speed, may result in wear, abrasion, and/or erosion to the inner surfaces 28. Accordingly, the disclosed embodiments provide a wear-resistant liner 36 disposed on at least a portion of the inner surfaces 28 to reduce wear, abrasion, and erosion to the inner surfaces 28. In some embodiments, multiple wear-resistant liners 36 may be provided to protect the inner surfaces 28, rather than a single, continuous wear-resistant liner 36. It should be appreciated that wear-resistant liners 36 manufactured using the disclosed techniques may be used on any suitable wear surface or liner of any suitable apparatus exposed to high wear, abrasion, and/or erosion.

FIG. 2 illustrates a cross-section of a portion of the wear-resistant liner 36, in accordance with an embodiment. As illustrated, the wear-resistant liner 36 is a composite liner including two or more materials. In particular, the wear-resistant liner 36 includes a plurality of inserts 38 that are constructed from a highly wear-resistant material, such as ceramic, ceramic composite, tungsten carbide, steel, etc. The inserts 38, such as ceramic inserts, may be particularly resistant to abrasion, but may crack due to high impact. The wear-resistant liner 36 also includes a matrix material 40 that at least partially surrounds the inserts 38. That is, in some embodiments, one or more faces of one or more inserts 38 may be exposed. For example, as illustrated, the top face of each insert 38 may be exposed. However, in other embodiments, the matrix material 40 may cover each face of each insert 38. The matrix material 40 may be a highly durable material, such as a polymer, an elastomer, a urethane (e.g., polyurethane), a silicone, a rubber, and so forth. The matrix material 40 may deflect (e.g., yield) to high impact flows, and may protect the inserts 38 from the high impact flows. As will be described in more detail below, the wear-resistant liner 36 may be manufactured by embedding the inserts 38 within the matrix material 40. The wear-resistant liner 36 may be manufactured such that each insert 38 is disposed at a distance 41 from neighboring inserts 38. In some embodiments, the distance between inserts 38 may vary. In certain embodiments, one or more of the inserts 38 may be disposed directly adjacent to neighboring inserts 38.

As will be described in more detail below, each insert 38 includes at least one retention feature 42 on at least one face 44 of the insert 38. For example, in some embodiments, each face of an insert 38 may include at least one retention feature 42. In some embodiments, a face of an insert 38 may include two or more retention features 42, which may be the same or different. In some embodiments, the retention features 42 may differ among faces of the insert 38. Further, in some embodiments, the at least one retention feature 42 may be the same or different between different inserts 38. Further, the placement of the at least one retention feature 42 of different inserts 38 may be the same or may vary. The at least one retention feature 42 may include a rough surface area, an adhesive, and/or mechanical locking features (e.g., a recess, a groove, a ridge, a step, a slot, etc.). The retention feature 42 may increase the adhesion between the insert 38 and the matrix material 40 to block the removal of the insert 38 from the matrix material 40.

FIG. 3 illustrates a perspective view of an embodiment of the insert 38 with retention features 42. The insert 38 may include any suitable geometry. As illustrated, the insert 38 may be a hexagonal prism with hexagonal faces 46 and rectangular faces 48. In some embodiments, having an insert 38 in the shape of a hexagonal prism may be desirable due to the angles of the vertices of the hexagonal base faces 46. In particular, the hexagonal faces 46 include larger angles 49 than some other polygons (e.g., triangles, squares, rectangles, and pentagons), and providing faces with larger angles may reduce stress concentrations and thereby decrease the likelihood of the angles rupturing the matrix material 40. However, in other embodiments, the insert 38 may include faces 46 of any other suitable shape, such as a triangle, a square, rectangle, a pentagon, an octagon, a circle, an oval, and so forth. Additionally, the insert 38 may include any suitable dimensions. In the illustrated embodiment, the insert 38 includes a length 50, a width 52, and a height 54. In some embodiments, the length 50, the width 52, and the height 54 may each be between approximately 1 millimeter (mm) and 10 centimeters (cm), 5 mm and 5 cm, 1 cm and 3 cm, or any other suitable distance.

In the illustrated embodiment, one of the retention features 42 of the insert 38 is an area 56 of increased roughness. While the rough area 56 is illustrated on only one side face 48, it should be appreciated that the rough area 56 may be provided on more than one face of the insert 38 or on all of the faces of the insert 38. Further, it should noted that the rough area 56 may be provided over the entire surface area of the face(s) of the insert 38, rather than just a portion as illustrated. The rough area 56 increases the contact surface area between the insert 38 and the matrix material 40, as compared to a smooth area, and thus, may increase the retention of the insert 38 within the matrix material 40 by increasing the available surface area for adhesion of the insert 38 to the matrix material 40. The rough area 56 may be produced using any suitable techniques. For example, in some embodiments, the rough area 56 may be produced by adhering particles (e.g., ceramic particles, metallic particles, etc.) to the face of the insert, by etching, or by using mechanical machining methods.

The illustrated embodiment of the insert 38 includes an additional retention feature 42. In particular, the additional retention feature 42 is an adhesive layer 58 disposed on a side face 48 of the insert. Similar to the rough area 56, the adhesive layer 58 may be disposed on a portion of or the entirety of the side face 48, and may be disposed on more than one face of the insert 38. The adhesive layer 58 may be applied to the desired faces of the insert 38 before the insert 38 is embedded within the matrix material 40.

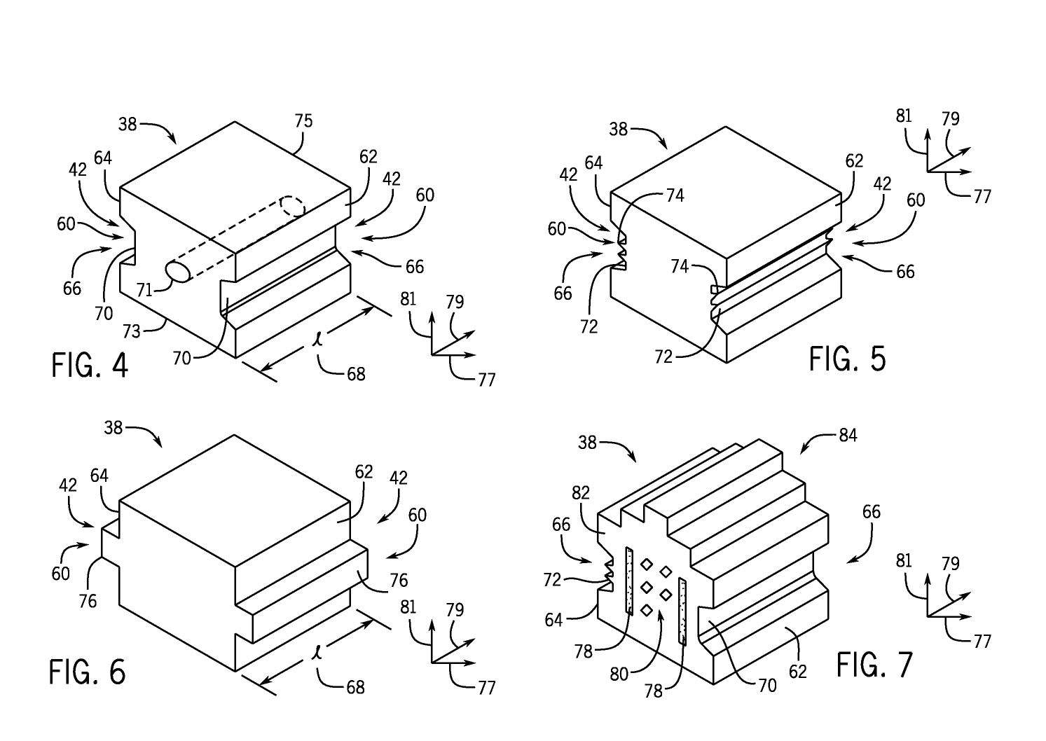

As noted above, the retention features 42 of the insert 38 may also include mechanical locking features, such as recesses, grooves, slots, ridges, protrusions, and so forth. Various embodiments of mechanical locking features will be described in more detail below with respect to FIGS. 4-7. It should be appreciated that the embodiments described herein are provided as examples and are not to be limiting. In particular, while different embodiments of the retention features may be illustrated using different figures, it should be noted that any of the disclosed embodiments may be combined on any one of the inserts 38 shown in the figures.

FIG. 4 illustrates a perspective view of an embodiment of the insert 38 including mechanical locking features 60 on first and second side faces 62 and 64 of the insert 38. In particular, the mechanical locking features 60 include recesses 66 (e.g., groove, recess, etc.) in the first and second side walls 62 and 64. The recesses 66 increase the surface area of the first and second side faces 62 and 64 as compared to an insert 38 having generally planar faces. As noted above, the increased surface area may increase the adhesion between the insert 38 and the matrix material 40. While the illustrated recesses 66 extend across the length 68 of the side faces 62 and 64, in other embodiments, the recesses 66 may extend across only a portion of the length 70. The recesses 66 may be any suitable shape. In some embodiments, the recesses 66 may include a generally trapezoidal cutout as illustrated, or may include a triangular, square, rectangular, or circular cutout.

In some embodiments, the insert 38 may also include a recess 71 (e.g., hole) that extends from a third side face 73 to a fourth side face 75. The recess 71 may be circular, as illustrated, or any other suitable shape, such as a triangle, square, rectangle, etc. Further, while the recess 71 extends across the length 68 of the insert 38 in the illustrated embodiment, in other embodiments, the recess 71 may extend across only a portion of the length 70 or may extend from the third side face 73 toward the first side face 62, the second side face 64, and/or the base faces of the insert 38. The recesses 66 and 71 increase the contact surface area between the insert 38 and the matrix material 40, which may block movement of the insert 38 within the matrix material 40 across the x-axis 77, the y-axis 79, and the z-axis 81.

In the illustrated embodiment, each inset 66 includes a generally planar surface 70. However, in other embodiments, the recesses 66 may be provided with nonplanar surfaces to further increase the surface area between the insert 38 and the matrix material 40. For example, as illustrated in FIG. 5, the recesses 66 may include nonplanar surfaces 72 having a plurality of ridges 74.

In other embodiments, as illustrated in FIG. 6, the insert 38 may include ridges 76 (e.g., protrusions) extending from faces (e.g., the side faces 62 and 64) of the insert 38. The ridges 76 may be any suitable shape, such as trapezoidal, triangular, square, rectangular, circular, and so forth. Additionally, while the ridges 76 extend across the length 68 of the side faces 62 and 64, in other embodiments, the ridges 76 may extend across only a portion of the length 68. Similar to the recesses 66 and 71, the ridges 76 also increase the contact surface area between the insert 38 and the matrix material 40, which may block movement of the insert 38 within the matrix material 40 across the x-axis 77, the y-axis 79, and the z-axis 81.

FIG. 7 illustrates an embodiment of the insert 38 including a plurality of different types of mechanical locking features 60 disposed about the faces of the insert 38. For example, the insert 38 may include the recess 66 with the planar surface 68 on the first side face 62 of the insert 38. The insert 38 may also include the recess 66 with the nonplanar surface 72 on the second face 64. Additionally, the insert 38 may include first and second slots 78 and a plurality of protrusions 80 on a third face 82. Additionally, the insert 38 may include a stepped base face 84. In some embodiments, the stepped base face 84 may be on a bottom face of the insert 38, while the top face of the insert 38 may be substantially planar. While the second base face of the insert 38 is not visible in the illustrated embodiment, the second base face may also include any suitable combination of the retention features 42 described above (e.g., the rough area 56, the adhesive layer 58, and/or the mechanical locking features 60).

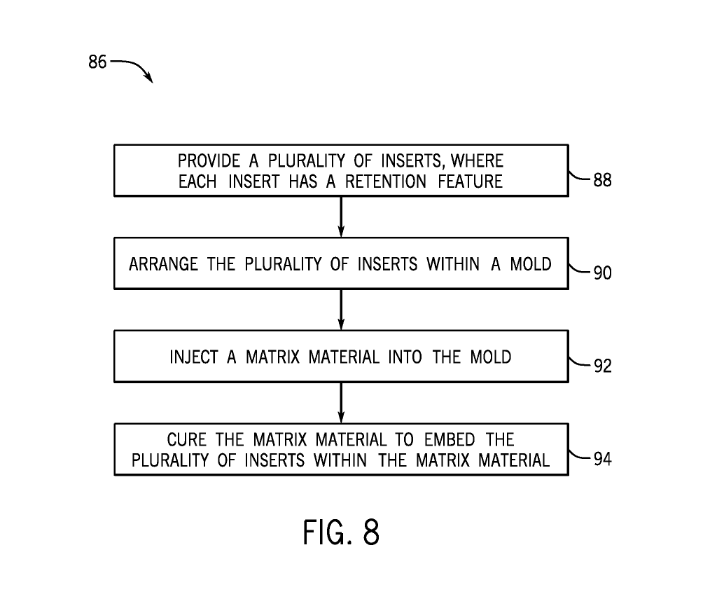

FIG. 8 is a flow chart of a method 86 for making the wear-resistant liner 36. The method 86 includes providing a plurality of inserts (e.g., inserts 38) having a least one retention feature 42 (e.g., the rough area 56, the adhesive layer 58, and/or the mechanical locking features 60) (block 88). In some embodiments, providing the inserts 38 may include manufacturing the inserts 38 with the retention features 42. For example, the inserts 38 may be manufactured using a mold having the retention features. In other embodiments, the retention features 42 may be formed using manufacturing cutting techniques (e.g., turning, milling, grinding, drilling, EDM, laser cutting, water jet cutting, ECM, etc.). Additionally, the retention feature 42 may be formed by applying one or more adhesive layers on one or more faces of the inserts, or adhering particles to one or more faces of the insert 38 to create a rough area.

The method 86 also includes arranging the plurality of inserts 38 within a mold (block 90). For example, the mold may be shaped to correspond with a desired wear-resistant liner 36 shape. In other embodiments, the mold may be shaped to correspond with a portion of a desired wear-resistant liner 36 shape. Additionally, arranging the plurality of inserts 38 within the mold may include arranging the inserts within a base material disposed in the mold or arranging the inserts within a base material and placing the base material including the inserts within the mold. The base material may be used to facilitate a desired arrangement of inserts 38. For example, the base material may be a mesh base (e.g., polypropylene) having a plurality of spaces (e.g., holes) configured to receive the inserts 38. The spaces may be sized to fit the desired inserts 38, and the spaces may be spaced apart to create a desired distance between the inserts 38. Further, the method 86 includes injecting the matrix material 40 (e.g., a liquid polymer, elastomer, polyurethane, etc.) into the mold (block 92) and curing the matrix material 40 to embed (e.g., suspend, surround, etc.) the inserts 38 within the matrix material 40 (block 94). The manufactured wear-resistant liner 36 may then be installed into a desired component using retaining rings, bolts, or any other suitable technique.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A system, comprising:
a wear-resistant liner, comprising:
a matrix material; and
a plurality of inserts embedded within the matrix material, wherein one or more inserts of the plurality of inserts comprises a retention feature, wherein the retention feature is configured to increase adhesion between the one or more inserts of the plurality of inserts and the matrix material.

2. The system of claim 1, wherein the matrix material comprises an elastomeric material.

3. The system of claim 1, wherein the matrix material comprises polyurethane.

4. The system of claim 1, wherein one or more of the inserts of the plurality of inserts are ceramic.

5. The system of claim 1, wherein the retention feature comprises a mechanical locking feature.

6. The system of claim 5, wherein the mechanical locking feature comprises at least one of a recess, a groove, a ridge, or a protrusion.

7. The system of claim 1, wherein the retention feature comprises a surface area with an increased roughness.

8. The system of claim 1, wherein the retention feature comprises an adhesive layer.

9. A method, comprising:
providing a plurality of inserts, wherein one or more inserts of the plurality of inserts comprises a retention feature; and
embedding the plurality of inserts within a matrix material;
wherein the retention feature is configured to increase adhesion between the one or more inserts of the plurality of inserts and the matrix material.

10. The method of claim 9, wherein embedding the plurality of inserts within the matrix material comprises:
arranging the inserts in a mold; and
injecting the matrix material into the mold.

11. The method of claim 9, wherein providing the plurality of inserts comprises removing a portion of one or more of the plurality of inserts to form the retention feature.

12. The method of claim 9, wherein the retention feature comprises at least one of a recess, a slot, or a groove.

13. The method of claim 9, wherein the retention feature comprises particles adhered to one or more inserts of the plurality of inserts.

14. The method of claim 9, wherein the retention feature comprises an adhesive layer on one or more inserts of the plurality of inserts.

15. A system, comprising:
a classifier system configured to separate phases of a multi-phase flow, comprising:
a housing comprising:
a head portion comprising an inlet and a first outlet;
a separation portion comprises a second outlet; and
a wear-resistant liner disposed on a portion of an interior surface of the head portion or the separation portion, wherein the wear-resistant liner comprises:
a matrix material; and
a plurality of inserts embedded within the matrix material, wherein one or more inserts of the plurality of inserts comprises a retention feature, wherein the retention feature is configured to increase adhesion between the one or more inserts of the plurality of inserts and the matrix material.

16. The system of claim 15, wherein the classifier system comprises a hydrocyclone.

17. The system of claim 15, wherein the matrix material comprises an elastomer.

18. The system of claim 15, wherein the plurality of inserts comprises a plurality of ceramic inserts.

19. The system of claim 15, wherein the retention feature comprises at least one of a recess, a groove, a ridge, or a protrusion.

20. The system of claim 15, wherein the retention feature comprises adhered particles on a face of one or more inserts of the plurality of inserts.
